(19) United States
(12) Patent Application Publication
(10) Pub. No.: US 2026/0319155 A1
(43) Pub. Date: Oct. 15, 2026

(54) VOLUME HOLOGRAM ELEMENT AND IMAGE DISPLAY APPARATUS

(71) Applicant: FUJIFILM Corporation, Tokyo (JP)

(72) Inventor: Makoto KAMO, Minamiashigara-shi (JP)

(73) Assignee: FUJIFILM Corporation, Tokyo (JP)

(21) Appl. No.: 19/717,114

(22) Filed: Jun. 23, 2026

Related U.S. Application Data
(63) Continuation of application No. 18/532,061, filed on Dec. 7, 2023.

(30) Foreign Application Priority Data
Jan. 31, 2023 (JP) 2023-012654

(51) Int. Cl. G02B 5/32; G02B 27/01

(52) U.S. Cl. CPC G02B 5/32; G02B 2027/0174

(57) ABSTRACT

An object of the present invention is to provide a volume hologram element that is capable of diffracting light having different wavelengths and has less optical loss. Another object of the present invention is to provide an image display apparatus including a volume hologram element. A volume hologram element has a first main surface and a second main surface opposite to the first main surface, and has a thickness equal to or greater than 10 μm, the volume hologram element has a non-hologram region and a hologram region that surrounds the non-hologram region in an in-plane direction, a plurality of interference fringes each of which selectively diffracts light having a different wavelength are formed in the entire hologram region, and all of the plurality of interference fringes have no discontinuous portions in the hologram region.

### CROSS-REFERENCE TO RELATED APPLICATIONS

This application is a Continuation of copending Application No. 18/532,061, filed on Dec. 7, 2023, which claims priority under 35 U.S.C. § 119(a) to Application No. 2023-012654, filed in Japan on Jan. 31, 2023, all of which are hereby expressly incorporated by reference into the present application.

### BACKGROUND OF THE INVENTION

### 1. Field of the Invention

The present invention relates to a volume hologram element and an image display apparatus.

### 2. Description of the Related Art

As means for providing virtual reality (VR) and augmented reality (AR) to users, a head mounted display (HMD), such as VR goggles and AR glasses, has been put to practical use.

An example of an optical element that is usable for controlling a direction of light in an optical system, such as an HMD, is a volume hologram element (volume-phase type hologram optical element) having a function as a lens that diffracts and deflects incident light.

The volume hologram element can be manufactured, for example, by performing interference exposure on a photosensitive hologram material. In more detail, in a case where an intensity distribution of fine light in a hologram recording member made of a photosensitive hologram material is formed using an interference phenomenon of light caused by intersecting two or more luminous fluxes coherent to each other, a chemical change and/or a physical change according to the distribution is induced on the hologram material. As a result, a fringe pattern structure (hereinafter, also described as "interference fringes") in which a high refractive index region and a low refractive index region are alternately arranged is formed in the hologram recording member, such interference fringes become a diffraction grating, and a volume hologram element having a function as a lens that diffracts incident light is obtained.

A manufacturing method for a volume hologram element using interference exposure and a volume hologram element manufactured by the manufacturing method have been hitherto suggested.

For example, JP2010-072148A describes a manufacturing method for a volume-phase type transmissive hologram optical element in which a plurality of hologram elements are formed on a substrate by repeating a step of forming a hologram element to be a unit composing the hologram optical element at a position eccentric to a rotation axis of a substrate and a step of rotating the substrate around the rotation axis by a predetermined angle, and each hologram element is formed by exposing two luminous fluxes including a luminous flux that diverges from the rotation axis of the substrate and is incident on the hologram photosensitive material and a luminous flux that gives an emission spot to the hologram photosensitive material formed at a position eccentric to the rotation axis of the substrate, to a hologram photosensitive material formed on the substrate, and a hologram optical element manufactured by the manufacturing method.

### SUMMARY OF THE INVENTION

Recently, there is a demand for further improvement of optical characteristics of the volume hologram element. Accordingly, as a result of examining the optical characteristics of the volume hologram element while referring to the technique described in JP2010-072148A, the manufacturing method described in JP2010-072148A has a problem that a region exposed in an overlapping manner occurs because a hologram region is formed by performing interference exposure a plurality of times.

Here, FIG. 11 conceptually shows an example of a configuration of an exposure device of the related art that manufactures a volume hologram element using interference exposure. An exposure device 60 shown in FIG. 11 comprises a light source 64 comprising a laser 62, a polarization beam splitter 68 that splits laser light M emitted from the laser 62 into two luminous fluxes MA and MB, and mirrors 70A and 70B are disposed on optical paths of the two split luminous fluxes MA and MB, respectively.

The exposure device 60 shown in the drawing is a so-called dual luminous flux exposure system. The laser light M emitted from the laser 62 is emitted as parallel light from the light source 64 via a optical element, such as a lens, and a beam expander, and the luminous fluxes MA and MB split in the polarization beam splitter 68 are reflected by the mirrors 70A and the 70B, respectively. As shown in the drawing, by disposing a hologram recording layer 74 made of a photosensitive hologram material formed on a substrate 72 at a position where the reflected luminous fluxes MA and MB overlap each other, and setting the luminous flux MA and the luminous flux MB to be coherent to each other by optical elements, such as a phase difference plate and a filter (not shown), disposed on the optical paths, an intensity distribution by light interference of the luminous flux MA and the luminous flux MB occurs inside the hologram recording layer 74, and interference fringes that function as a hologram are formed.

In manufacturing a volume hologram element that functions as a lens, using such an exposure device, because it is necessary to successively perform interference exposure using two luminous fluxes with different optical axes, a volume hologram element in which a part of a plurality of exposure regions overlap each other or a volume hologram element in which a part of a desired region is not exposed is manufactured. In a case where there is a region where exposure is performed in an overlapping manner and/or a region where exposure is not performed, in the volume hologram element, deterioration of optical performance, such as deterioration of diffraction efficiency, light leak, and stray light, occurs in such regions, and as a result, deterioration (optical loss) of utilization efficiency of light in the volume hologram element occurs.

JP2010-072148A describes that it is possible to reduce a region where exposure is performed in an overlapping manner, by performing exposure using a light shielding member. However, to prevent the occurrence of both a region that overlaps an adjacent exposure region and a region where exposure is not performed and interference fringes are not formed, it is necessary to accurately control positions of exposure regions and exposure conditions in interference exposure at each time. Therefore, in the technique described in JP2010-072148A, it is considered that there is actually a limit to reduction of overlapping of the exposure regions and/or a region where exposure is not performed, in the volume hologram element.

An object of the present invention is to solve such a problem in the related art and is to provide a volume hologram element that is capable of diffracting light having different wavelengths and has less optical loss. Another object of the present invention is to provide an image display apparatus comprising a volume hologram element.

As a result of conducting an extensive investigation to achieve the objects, the present inventors have found that the objects can be achieved by the following constitution.
[1] A volume hologram element that has a first main surface and a second main surface opposite to the first main surface, and has a thickness equal to or greater than 10 μm, in which the volume hologram element has a non-hologram region and a hologram region that surrounds the non-hologram region in an in-plane direction, a plurality of interference fringes each of which selectively diffracts light having a different wavelength are formed in the entire hologram region, and all of the plurality of interference fringes have no discontinuous portions in the hologram region.
[2] The volume hologram element according to [1], in which the thickness is 50 to 800 μm.
[3] The volume hologram element according to [1] or [2], in which, in the hologram region, a slant angle of at least one interference fringe among the plurality of interference fringes monotonously increases from the non-hologram region toward an outer peripheral end of the hologram region and/or a period of at least one interference fringe among the plurality of interference fringes is monotonously narrowed from the non-hologram region toward the outer peripheral end of the hologram region.
[4] The volume hologram element according to any one of [1] to [3], in which, in the hologram region, a slant angle of at least one interference fringe among the plurality of interference fringes monotonously increases from the non-hologram region toward an outer peripheral end of the hologram region or a period of at least one interference fringe among the plurality of interference fringes is monotonously narrowed from the non-hologram region toward the outer peripheral end of the hologram region.
[5] The volume hologram element according to any one of [1] to [4], in which, in a case where light having a wavelength to be diffracted by at least one interference fringe among the plurality of interference fringes is incident on the first main surface in the hologram region, an angle between a vertical line drawn from a convergent point where diffracted light diffracted by the at least one interference fringe and emitted from the second main surface converges, to the second main surface and a line segment that connects the convergent point and an outer peripheral end of the hologram region is equal to or greater than 50°.
[6] The volume hologram element according to any one of [1] to [5], in which three or more interference fringes are formed as the plurality of interference fringes, and in a case where three or more kinds of light having wavelengths to be selectively diffracted by the respective three or more interference fringes are incident on the first main surface, the three or more kinds of light diffracted by the three or more interference fringes in the hologram region, respectively, and emitted from the second main surface converge at the same convergent point.
[7] An image display apparatus comprising the volume hologram element according to any one of [1] to [6], and a display element that emits an image to the volume hologram element.

According to the present invention, it is possible to provide a volume hologram element that is capable of diffracting light having different wavelengths and has less optical loss. Also, according to the present invention, it is possible to provide an image display apparatus comprising a volume hologram element.

### BRIEF DESCRIPTION OF THE DRAWINGS

FIGS. 1A and 1B are schematic views showing an example of a volume hologram element according to an embodiment of the present invention.

FIG. 2 is a perspective view showing an example of the volume hologram element according to the embodiment of the present invention.

FIG. 3 is an enlarged cross-sectional view showing a part of a cross section of the volume hologram element shown in FIG. 2.

FIG. 4 is a schematic view showing an example of optical characteristics of the volume hologram element according to the embodiment of the present invention.

FIG. 5 is a schematic view showing an example of an exposure device that is used for manufacturing the volume hologram element according to the embodiment of the present invention.

FIG. 6 is a schematic view showing an outer shape of an objective lens shown in FIG. 5.

FIG. 7 is a schematic view showing an example of a utilization aspect of the volume hologram element according to the embodiment of the present invention.

FIG. 8 is a schematic view showing another example of an aspect of manufacturing the volume hologram element according to the embodiment of the present invention.

FIG. 9 is a schematic view showing an example of a utilization aspect of the volume hologram element according to the embodiment of the present invention.

FIGS. 10A and 10B are conceptual diagrams showing an example of an embodiment of a head mounted display including the volume hologram element according to the embodiment of the present invention.

FIG. 11 is a schematic view showing an example of an exposure device of the related art that is used for manufacturing a volume hologram element.

### DESCRIPTION OF THE PREFERRED EMBODIMENTS

Hereinafter, a volume hologram element and an image display apparatus of the present invention will be described in detail with reference to an embodiment shown in the drawings.

Description of configuration requirements described below is provided based on a representative embodiment of the present invention, but the present invention is not limited to such an embodiment.

All drawings described below are conceptual diagrams for describing the present invention, and the size, the thickness, the positional relationship, and the like of each member, part, and the like do not always coincide with actual ones.

In the present specification, a numerical range that is represented using "to" includes numerical values before and after "to" as a lower limit value and an upper limit value.

### Volume Hologram Element

A volume hologram element according to an embodiment of the present invention is a volume hologram element that has a first main surface and a second main surface opposite to the first main surface, and has a thickness equal to or greater than 10 μm, in which the volume hologram element has a non-hologram region and a hologram region that surrounds the non-hologram region in an in-plane direction, a plurality of interference fringes each of which selectively diffracts light having a different wavelength are formed in the entire hologram region, and all of the plurality of interference fringes have no discontinuous portions in the hologram region.

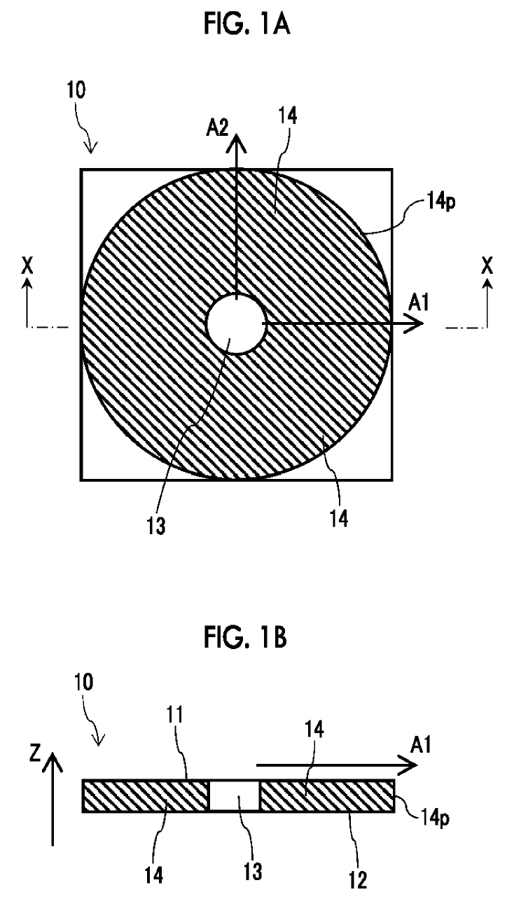

FIGS. 1A and 1B conceptually show an example of the configuration of a volume hologram element according to an embodiment of the present invention. FIG. 1A is a plan view showing an example of the configuration of a volume hologram element 10 according to the embodiment of the present invention, and FIG. 1B is a cross-sectional view taken along the line X-X in FIG. 1A. A cut section of the volume hologram element 10 shown in FIG. 1B includes a thickness direction (Z direction).

As shown in the drawing, the volume hologram element 10 has a first main surface 11 and a second main surface 12 opposite to the first main surface 11. The volume hologram element 10 has a non-hologram region 13 and a hologram region 14 that surrounds the non-hologram region 13 in an in-plane direction.

In the present specification, the first main surface 11 and the second main surface 12 of the volume hologram element 10 are also simply described as a "main surface" in a case where there is no need for distinction. A direction parallel to the main surfaces (first main surface 11 and the second main surface 12) is also described as an "in-plane direction".

In FIG. 1, a direction indicated by an arrow Z is a thickness direction of the volume hologram element 10, in other words, a normal direction to the main surface. Both directions indicated by arrows A1 and A2 are a direction from the non-hologram region 13 toward an outer peripheral end 14p of the hologram region 14 in the in-plane direction, in other words, a direction from a central portion of the volume hologram element 10 toward the outside.

In the present specification, the direction indicated by the arrow A1, the direction indicated by the arrow A2, and the direction indicated by the arrow Z are also described as an "A1 direction", an "A2 direction", and a "Z direction", respectively. The direction from the non-hologram region toward the outer peripheral end of the hologram region represented by the A1 direction and the A2 direction is also described as an "A direction".

In the non-hologram region 13, an interference fringe that diffracts incident light is not formed. For this reason, the non-hologram region 13 functions as a transmissive region that does not diffract incident light and transmits incident light.

In the entire hologram region 14, a plurality of interference fringes each of which diffracts light having a different wavelength are formed. All of a plurality of interference fringes formed in the hologram region 14 of the volume hologram element 10 according to the embodiment of the present invention have no discontinuous portions.

In the present specification, a discontinuous portion in the interference fringe means a disconnected part of a fringe composing the interference fringe inside the hologram region excluding an interface at which the hologram region is adjacent to another region. That is, a case where the interference fringes have no discontinuous portions means that all the fringes composing the interference fringes are not disconnected and are continuous in the hologram region.

An example where an interference fringe having a discontinuous portion is formed inside the hologram region includes a first example where interference exposure is performed on a part of the hologram region a plurality of times, a second example where a blank region is formed in which interference exposure is not performed on a part of a region where an interference fringe should be formed, and a third example where the entire hologram region is manufactured by successively forming interference fringe regions having a predetermined shape to be arranged with no gap as described in JP2010-072148A.

Among the above-described examples, in the first example, diffraction efficiency is deteriorated in a region where interference fringes are formed in an overlapping manner by interference exposure at a plurality of times, and light utilization efficiency is deteriorated. In the second example, because incident light is not diffracted in the blank region where an interference fringe is not formed, light leak occurs. In addition, even in the third example, it is difficult to suppress overlapping of fine interference fringes or the occurrence of a blank region in a boundary portion of two interference fringes formed by individual interference exposure. Because matching of periods of two interference fringes in contact with each other in the boundary portion is hardly realized, and deviation in refractive index between the interference fringes occurs, it is considered that deterioration of diffraction efficiency or the occurrence of stray light and the like is inevitable.

In contrast, in the volume hologram element 10 according to the embodiment of the present invention, no discontinuous portions are formed in all of a plurality of interference fringes in the hologram region 14 as shown in FIG. 1A. This is because the interference fringe that selectively diffracts one wavelength is formed by single interference exposure. With this, it is possible to suppress deterioration of diffraction efficiency and the occurrence of light leak, stray light, and the like due to the above-described discontinuous portions, and to suppress optical loss in the volume hologram element 10.

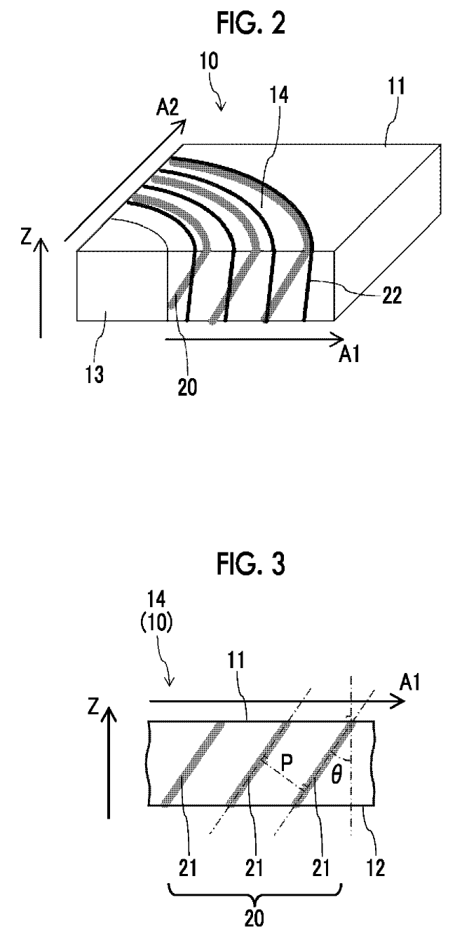

Next, a plurality of interference fringes formed in the entire hologram region 14 will be described with reference to FIG. 2.

FIG. 2 is a perspective view showing an example of the configuration of the volume hologram element 10. In FIG. 2, a part of the volume hologram element 10 is cut out, and the first main surface 11 and a cross section (A1-Z plane) including the A1 direction and the Z direction are shown.

In the hologram region 14, a first interference fringe 20 that diffracts first light and a second interference fringe 22 that diffracts second light are formed. In FIG. 2, lines representing the first interference fringe 20 and the second interference fringe 22 mean intersection lines of a surface made of continuous points having a maximum refractive index in the hologram region 14 and the first main surface 11 or the A1-Z plane.

As shown in the drawing, the first interference fringe 20 and the second interference fringe 22 are composed of a periodic structure in which a high refractive index region and a low refractive index region are alternately arranged along the A direction (A1 direction and A2 direction) from the inside toward the outside of the volume hologram element 10 in the hologram region 14. In observing the hologram region 14 from the normal direction to the main surface of the volume hologram element 10, the first interference fringe 20 and the second interference fringe 22 are composed of a plurality of concentric circular fringes.

On the other hand, in the first interference fringe 20 and the second interference fringe 22 shown in FIG. 2, both a period P (described below) that is an interval of two fringes adjacent to each other and a slant angle θ (described below) that is an inclination angle of a fringe in the cross section including the A1 direction and the Z direction are different. The volume hologram element 10 shown in the drawing has a function of diffracting light having different wavelengths according to the respective interference fringes because the first interference fringe 20 and the second interference fringe 22 that are different in the period P and the slant angle θ are in the hologram region 14.

Here, the period P and the slant angle of the interference fringes formed in the hologram region 14 will be described with reference to FIG. 3.

FIG. 3 is an enlarged cross-sectional view showing a part of a cross section in the A1-Z plane of the volume hologram element 10 shown in FIG. 2. In FIG. 3, for description, only the first interference fringe 20 out of the interference fringes that compose the hologram region 14 is shown. The first interference fringe 20 is composed of a plurality of fringes 21 periodically arranged at predetermined intervals along the A1 direction, and a plurality of fringes 21 mean intersection lines of a surface made of continuous points having a maximum refractive index in the hologram region 14 and the A1-Z plane.

Here, a distance between two adjacent fringes among a plurality of fringes that compose each interference fringe composing the hologram region is also described as a "period P". In the hologram region 14 shown in FIG. 3, the period P of the first interference fringe 20 means a shortest distance between two adjacent fringes 21 among a plurality of fringes 21 arranged along the A1 direction from the non-hologram region 13 (see FIG. 2) toward the outer peripheral end 14p (see FIG. 2) of the hologram region 14.

As shown in FIG. 3, an angle between the fringe (fringe 21) that composes each interference fringe of the hologram region and a normal line (Z direction) to the main surface of the volume hologram element is also described as a "slant angle θ". In observing the volume hologram element in a cross section including a line segment that connects the shortest distance between two adjacent fringes, in a case where the fringe that composes the interference fringe is perpendicular to the main surface, the slant angle θ is 0°, and in a case where the above-described fringe is parallel to the main surface, the slant angle θ is 90°.

In the volume hologram element according to the embodiment of the present invention, a plurality of interference fringes that are different in at least one of the period P or the slant angle θ described above are formed in the hologram region, so that light having a different wavelength according to each interference fringe is diffracted.

Each interference fringe formed in the hologram region of the volume hologram element exhibits a function as an optical element that changes a traveling direction of light in a case where at least one of the period P or the slant angle θ changes according to the position of the fringe.

The period P and the slant angle θ of the interference fringe that composes the hologram region are suitably adjusted according to an intended optical function.

In a case where the volume hologram element is made to function as a lens, it is preferable that the slant angle θ of the interference fringe formed in the hologram region monotonously increases or monotonously decreases along the A direction. In a case where the volume hologram element is made to function as a lens, it is preferable that the period P of the interference fringe formed in the hologram region is monotonously narrowed or is monotonously widened along the A direction (the direction from the non-hologram region toward the outer peripheral end of the hologram region).

Above all, it is more preferable that, in the hologram region, the slant angle θ of at least one interference fringe among a plurality of interference fringes monotonously increases along the A direction and/or the period P of at least one interference fringe among a plurality of interference fringes is monotonously narrowed along the A direction. From a point that the volume hologram element is made to function as a convex lens, it is further preferable that, in at least one interference fringe (particularly preferably, all interference fringes) among a plurality of interference fringes, the slant angle θ monotonously increases along the A direction or the period P is monotonously narrowed along the A direction.

The period P of the interference fringe and the slant angle θ of the interference fringe are suitably set in conformity with a wavelength of light to be controlled in the volume hologram element according to the embodiment of the present invention and a bending angle of light with respect to incident light.

For example, in a wavelength range of visible light described below, the period P of the interference fringe is, for example, 100 to 2000 nm, and is preferably 150 to 1800 nm. The slant angle θ of the interference fringe is, for example, 0 to 80°, and is preferably 3° to 75°.

In a case where the volume hologram element according to the embodiment of the present invention is used as an element that acts on ultraviolet light, the period P of the interference fringe can be set to 50 to 1600 nm, and in a case where the volume hologram element according to the embodiment of the present invention is used as an element that acts on infrared light, the period P of the interference fringe can be set to 150 to 3000 nm. The slant angle θ of the interference fringe in such cases can be set to be the same as a range of a slant angle for visible light.

The shapes of a plurality of interference fringes formed in the hologram region of the volume hologram element can be measured as a three-dimensional refractive index distribution in the volume hologram element shown in the drawing using a confocal laser microscope.

In observing the hologram region of the volume hologram element according to the embodiment of the present invention using the confocal laser microscope, as shown in FIG. 2, complicated patterns in which a plurality of interference fringes that diffract light having different wavelengths, respectively, overlap each other are observed. In FIG. 2, although each interference fringe is conceptually represented by a different line, a plurality of interference fringes are observed with substantially the same degree of contrast in actual measurement. Note that, within a visual field of a microscope, the interference fringes that diffract light having the same wavelength are observed as a periodic structure in which each of the period P and the slant angle θ is close to each other. Accordingly, a periodic structure that is included in an image obtained by the confocal laser microscope is separated by imaging processing, so that it is possible to specify each of a plurality of interference fringes corresponding to different wavelengths, and to obtain the period P and the slant angle θ of each interference fringe.

The confocal laser microscope is available, for example, as "Nanofinder" (product name) manufactured by Tokyo Instruments, Inc.

The period P and the slant angle θ of each interference fringe formed in the hologram region are determined by an angle with respect to the hologram recording member and a wavelength of each of object light and reference light, an angle between object light and reference light, and the like, in emitting object light and reference light to the hologram recording member to form the interference fringe.

Although the hologram region 14 where only the first interference fringe 20 and the second interference fringe 22 are formed is shown in FIG. 2, the hologram region of the volume hologram element according to the embodiment of the present invention is not limited only to the hologram region having two interference fringes each of which diffracts light having a different wavelength. That is, three or more interference fringes each of which selectively diffracts light having a different wavelength may be formed in the entire hologram region of the volume hologram element according to the embodiment of the present invention.

It is preferable that, in a case where a plurality (for example, three or more) of kinds of reference light having wavelengths to be selectively diffracted by a plurality of interference fringes formed in the hologram region are incident on the first main surface, a plurality of kinds of reference light are diffracted by a plurality (for example, three or more) of interference fringes in the hologram region, and then, three or more kinds of reproducing light (diffracted light) emitted from the second main surface converge on the same convergent point. With this, chromatic aberration of reproducing light is reduced, and in a case where the volume hologram element is used for an image display apparatus, such as an HMD, a focused multi-color image can be displayed.

The wavelength of light that is diffracted by the interference fringe formed in the hologram region is not particularly limited, and is suitably selected according to the purpose of utilization of the volume hologram element.

Examples of visible light that is diffracted by the interference fringe include red light in a wavelength range of about 600 to 800 nm, green light in a wavelength range of 500 to 600 nm, and blue light in a wavelength range of 420 to 500 nm. The interference fringe may selectively diffract visible light having a wavelength other than the above-described wavelength ranges or may selectively diffract light, such as infrared light and ultraviolet light, other than visible light.

An example of a combination of a plurality of interference fringes formed in the hologram region of volume hologram element according to the embodiment of the present invention is a combination of interference fringes that selectively diffract at least one kind of light selected from a group including red light, green light, and blue light. In a case where three or more interference fringes are formed in the hologram region, it is preferable that three interference fringes that selectively diffract red light, green light, and blue light, respectively, are formed.

The hologram region may have an interference fringe that selectively diffracts at least one kind of light selected from visible light, such as red light, green light, and blue light, and an interference fringe that selectively diffracts light, such as infrared light and ultraviolet light, other than visible light, or may have a plurality of interference fringes that selectively diffract only light other than visible light.

Although the shapes of the non-hologram region and the hologram region of the volume hologram element are not particularly limited, it is preferable that the non-hologram region has a circular columnar shape with the main surface as a bottom surface, and the hologram region has a cylindrical shape that surrounds the circular columnar non-hologram region and has the main surface as a bottom surface.

The respective interference fringes formed in the hologram region are preferably rotationally symmetrical around an axis perpendicular to the main surface passing through the non-hologram region while including the arrangement of the fringes composing each of the interference fringes, and are more preferably n-fold symmetrical with respect to any integer n.

The hologram region of the volume hologram element is configured rotationally symmetrically in this way, so that it is possible to easily apply the volume hologram element to a coaxial optical system.

A thickness of the volume hologram element according to the embodiment of the present invention is equal to or greater than 10 μm. With this, the diffraction performance of each interference fringe is more stabilized. From this viewpoint, the thickness of the volume hologram element is preferably equal to or greater than 30 μm, and is more preferably equal to or greater than 50 μm.

The thickness of the volume hologram element is preferably equal to or smaller than 3000 μm, is more preferably equal to or smaller than 1500 μm, and is further preferably equal to or smaller than 800 μm, from a viewpoint of a reduction in size of an image display apparatus (for example, an HMD) comprising the volume hologram element.

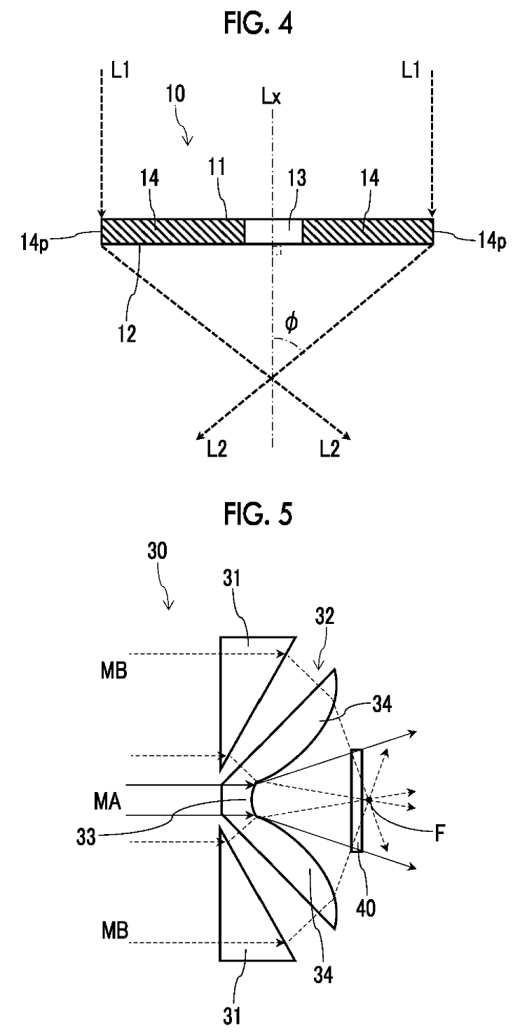

FIG. 4 schematically shows an example of optical characteristics of the volume hologram element according to the embodiment of the present invention.

FIG. 4 is a cross-sectional view of the volume hologram element 10 according to the embodiment of the present invention in the plane including the A direction and the Z direction like FIG. 1B.

In a case where reference light L1 having a wavelength that is selectively diffracted by the interference fringe formed in the hologram region 14 is incident on the first main surface 11 in the volume hologram element 10, the reference light L1 is diffracted by the interference fringe of the hologram region 14, is emitted as reproducing light L2 from the second main surface 12, and converges on a convergent point F. In this case, as shown in the drawing, an angle between a vertical line Lx drawn from the convergent point F to the second main surface 12 and a line segment that connects the convergent point F and the outer peripheral end 14p of the hologram region 14 is also described as an angle φ.

In a case where the volume hologram element is used for, for example, an HMD, an increase in numerical aperture (NA) and a reduction in focal length contribute to a reduction in size of the HMD. Thus, it is preferable that the angle φ obtained by the above-described method regarding the interference fringe formed in the hologram region is large.

As the volume hologram element 10, regarding at least one interference fringe (more preferably, all interference fringes) among a plurality of interference fringes formed in the hologram region 14, the angle φ measured by the above-described method is preferably equal to or greater than 45°, is more preferably equal to or greater than 50°, and is further preferably equal to or greater than 57°.

An upper limit of the angle φ is not particularly limited, but is less than 90° and may be equal to or smaller than 80°.

The angle φ of the interference fringe formed in the hologram region 14 of the volume hologram element 10 can be controlled by adjusting reference light and object light incident on a hologram recording member in a manufacturing method for a volume hologram element described below.

### Manufacturing Method for Volume Hologram Element

The volume hologram element according to the embodiment of the present invention can be manufactured by emitting reference light and object light having interference to a hologram recording member including a photosensitive hologram material to form interference fringes.

An example of the hologram recording member is an aspect where the hologram recording member comprises a substrate and a hologram recording layer including a photosensitive hologram material.

As the photosensitive hologram material, known photosensitive materials, such as a photopolymer, a silver salt material, and a dichromated gelatin, can be used, and the photopolymer is preferably used in that the photopolymer can be easily manufactured by a dry process.

The above-described hologram recording member can be manufactured by coating a recording layer forming composition including the photosensitive hologram material on the surface of the substrate and drying a coating film to form the hologram recording layer as needed.

A more preferred aspect of a hologram recording member is an aspect where a hologram recording layer has, as a photosensitive hologram material, a matrix polymer, a polymerizable monomer, and a photopolymerization initiator.

The paragraphs [0022] to [0102] of JP2017-523475A can be referred to regarding the hologram recording layer including the above-described photosensitive hologram material, and the description thereof is incorporated in the present specification.

The description of photosensitive materials or recording layers described in WO2005/078532A, JP2009-080475A, JP1996-101627A (JP-H8-101627A), JP2014-026116A, JP2007-017601A, and JP2010-250246A can be referred to regarding the photosensitive hologram material and the hologram recording layer, and the description thereof is incorporated in the present specification.

As the substrate of the hologram recording member, various sheet-shape materials (film and plate-shaped materials) capable of supporting the hologram recording layer can be used. Examples of the substrate include substrates composed of materials, such as glass, triacetylcellulose (TAC), polyethylene terephthalate(PET), polycarbonate, polyvinyl chloride, acryl, and polyolefin.

FIG. 5 shows an example of the configuration of an exposure device that is used for manufacturing the volume hologram element according to the embodiment of the present invention. In FIG. 5, for description, regarding each of an exposure device 30 and a hologram recording member 40 that is used for manufacturing the volume hologram element, only a cut section including optical axes of luminous fluxes MA and MB for use in interference exposure are shown. In FIG. 5, an optical path of the luminous flux MA is indicated by a solid line, and an optical path of the luminous flux MB is indicated by a broken line.

The exposure device 30 shown in FIG. 5 comprises a prism 31 and an objective lens 32. Though all are not shown, the exposure device 30 comprises a light source comprising a laser, an optical system that converts single light emitted from the laser into the luminous flux MA and the luminous flux MB and disposes the luminous flux MA and the luminous flux MB to have a common optical axis, and an optical system that guides the luminous fluxes MA and MB to the prism 31 and the objective lens 32. The above-described optical system can be provided by combining optical elements, such as filters, apertures, phase difference plates, a lens, and prisms, with reference to known techniques.

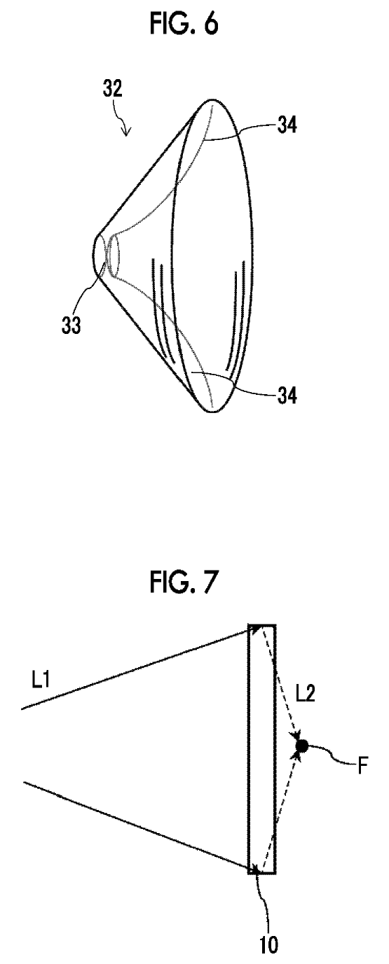

FIG. 6 schematically shows the outer shape of the objective lens 32 shown in FIG. 5.

As shown in FIG. 6, the objective lens 32 has a shape of a rotating body in which the cross section of the objective lens 32 shown in FIG. 5 rotates with the axis LA as a central axis, and is composed of a concave lens region 33 in a central portion through which an axis LA passes, and a convex lens region 34 that surrounds the periphery of the concave lens region 33.

An interference exposure method of the hologram recording member 40 using the exposure device 30 will be described in detail with reference to FIG. 5 again.

In the exposure device 30, light emitted from the laser (not shown) is split into the luminous flux MA and the luminous flux MB that are parallel light with the axis LA as a common optical axis, by the above-described optical system. In a plane perpendicular to the optical axis (axis LA), the shape of the luminous flux MA before incidence on the prism 31 is a circular shape, and the shape of the luminous flux MB before incidence on the prism 31 is an annular shape that surrounds the luminous flux MA. The luminous fluxes MA and MB can be converted from single laser light, for example, using an axicon lens, a prism, a central opening concave lens with an opening at the center, and the like in combination as a luminous flux conversion member.

The luminous flux MA that reaches the prism 31 moves straight as parallel light along the axis LA while the traveling direction is not converted by the prism 31, and is incident on the objective lens 32. The luminous flux MA incident on the objective lens 32 is converted into diverging light in which an optical path diameter is slightly extended while the optical axis is maintained, by the concave lens region 33 formed near the axis LA of the objective lens 32, and then, is incident on the hologram recording member 40.

On the other hand, the luminous flux MB is converted into parallel light toward the axis LA from parallel light along the axis LA by the prism 31, and then, is incident on the objective lens 32. The luminous flux MB incident on the objective lens 32 is converted into convergent light that is condensed toward the convergent point F on the axis LA, by the convex lens region 34 of the objective lens 32, and then, is incident on the hologram recording member 40.

As shown in FIG. 5, the hologram recording member 40 is disposed between the objective lens 32 and the convergent point F of the luminous flux MB such that the center of the hologram recording member 40 matches the axis LA and the main surface is perpendicular to the axis LA. The luminous flux MA (reference light) and the luminous flux MB (object light) are emitted to the hologram recording member 40 at this position, so that an interference fringe that has no discontinuous portion in a predetermined region and selectively diffracts light having a specific wavelength is formed inside the hologram recording member 40 by single interference exposure. The region where the interference fringe is formed is the hologram region of the volume hologram element according to the embodiment of the present invention.

On the other hand, in a central portion of the hologram recording member 40, there is a region 41 through which the luminous flux MA passes and the luminous flux MB does not pass. Because a strength distribution by interference of light does not occur in the region 41, a characteristic of diffracting light does not occur. The region 41 is the non-hologram region of the volume hologram element according to the embodiment of the present invention.

FIG. 5 conceptually shows only members important for forming the interference fringe among the members in the exposure device 30. While it is necessary to adjust the wavefronts of the luminous flux MA and the luminous flux MB by the optical system provided on an incidence side of the objective lens in forming the interference fringe by actual interference exposure, the wavefronts of the luminous fluxes can be adjusted using the above-described optical elements based on known techniques.

To manufacture the volume hologram element according to the embodiment of the present invention, the interference exposure according to the above-described method is repeatedly performed according to the number of interference fringes that are formed in the hologram region of the intended volume hologram element and selectively diffract different wavelengths. The interference exposure is performed the same number of times as the number of interference fringes formed in the hologram region, so that a plurality of interference fringes each of which selectively diffracts a different wavelength are formed in the hologram recording member.

In the second or later interference exposure, the interference exposure may be performed by emitting laser having a wavelength different from laser emitted in the previous (for example, first) interference exposure. Alternatively, in the second or later interference exposure, laser having the same wavelength as in the previous (for example, first) interference exposure is emitted, and the incidence angles of the luminous flux MA and the luminous flux MB are adjusted such that the interval P and the slant angle θ of interference patterns of light generated by exposure have desired values. Thereby, interference fringes that selectively diffract light having different wavelengths in desired directions can be formed. The incidence angles of the luminous flux MA and the luminous flux MB can be adjusted by changing the shape of the objective lens 32. That is, in a case where three interference fringes corresponding to visible light having three different wavelengths (for example, λ = 450 nm (blue), λ = 550 nm (green), and λ = 650 nm (red)) are formed by light having a single wavelength, the three interference fringes can be formed by replacing three objective lenses while the wavelength of exposure light that exposes the hologram recording member in the exposure device is set to be the same.

After the above-described interference exposure is performed, curing of the hologram recording layer (baking of the photopolymer) is performed as needed, so that a volume hologram element having a non-hologram region and a hologram region where a plurality of interference fringes that selectively diffracts light having different wavelengths are formed is manufactured.

FIG. 7 schematically shows an example of a utilization aspect of the volume hologram element according to the embodiment of the present invention manufactured according to the above-described method. For simplification of description, only the optical characteristics of one interference fringe formed in the hologram region will be described.

In a case where the reference light L1 having an optical path corresponding to the luminous flux MA is incident on the volume hologram element 10 having the hologram region where the above-described interference fringe is formed, the reference light L1 is selectively diffracted in the hologram region, is emitted as the reproducing light L2 having an optical path corresponding to the luminous flux MB from the volume hologram element 10, and is imaged at the convergent point F. With this, the volume hologram element 10 shown in FIG. 7 exhibits a function as a convex lens.

Light incident on the non-hologram region out of the reference light L1 is transmitted through the volume hologram element 10, and passes through near the convergent point F along the axis LA.

The interference exposure method of the hologram recording member for manufacturing the volume hologram element according to the embodiment of the present invention is not limited only to the aspect shown in FIG. 5.

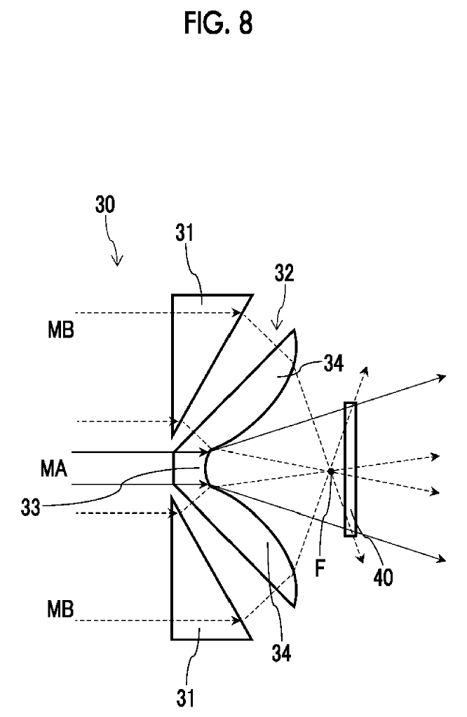

FIG. 8 shows another example of an aspect of manufacturing the volume hologram element according to the embodiment of the present invention using the exposure device 30 shown in FIG. 5. The exposure device 30, the prism 31, and the objective lens 32 shown in FIG. 8 are the same as those described above.

In the aspect shown in FIG. 5, although an aspect where the interference exposure is performed by disposing the hologram recording member 40 between the objective lens 32 and the convergent point F, and emitting the luminous flux MA and the luminous flux MB to the hologram recording member 40 has been shown, as shown in FIG. 8, the interference exposure can also be performed by disposing the hologram recording member 40 in an overlapping region of the luminous flux MA and the luminous flux MB formed on an opposite side to the objective lens 32 in the axis LA as viewed from the convergent point F.

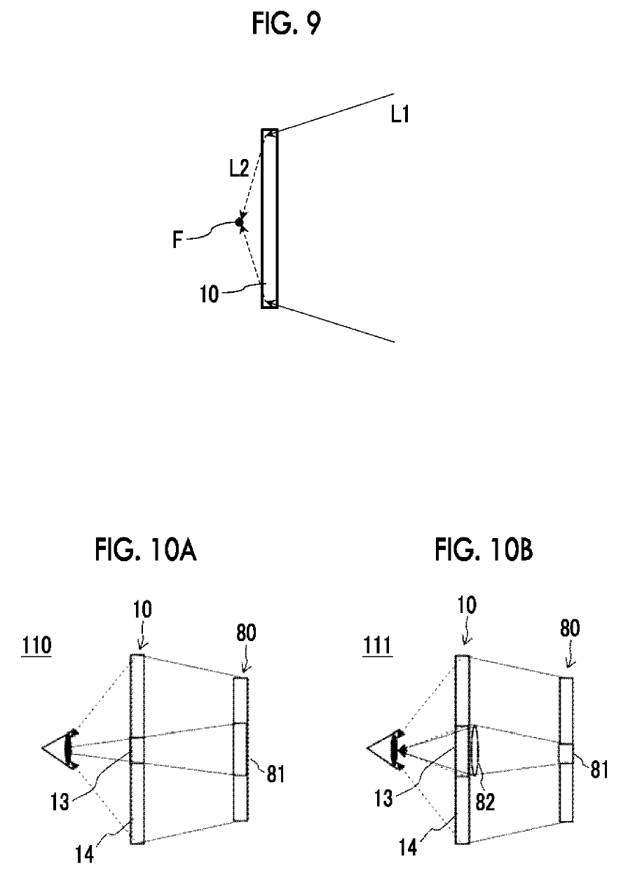

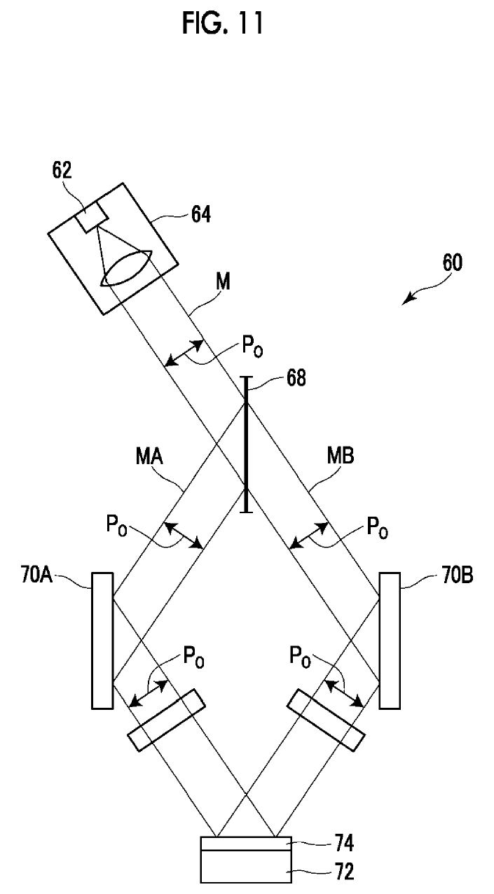

FIG. 9 schematically shows an example of a utilization aspect of the volume hologram element according to the embodiment of the present invention manufactured by performing the interference exposure according to the aspect shown in FIG. 8. Like FIG. 7, for simplification of description, only the optical characteristics of one interference fringe formed in the hologram region will be described.

In the volume hologram element manufactured by the above-described method, unlike the utilization aspect shown in FIG. 7, light is incident as the reference light L1 on the volume hologram element from a direction opposite to the traveling direction of the luminous flux MA. The incident reference light L1 is selectively diffracted in the hologram region 14, is emitted as the reproducing light L2 from the volume hologram element 10, is condensed toward the convergent point F from a direction opposite to the traveling direction of the luminous flux MB, and is imaged at the convergent point F. With this, the volume hologram element 10 shown in FIG. 9 exhibits a function as a convex lens.

The volume hologram element according to the embodiment of the present invention for which the utilization aspect has been described with reference to each of FIGS. 7 and 9 can also be made to exhibit a lens function of diffracting incident light in an optical path opposite to the optical path shown in each drawing.

For example, in the volume hologram element 10 shown in FIG. 9, light that passes through the convergent point F and diverges toward the volume hologram element 10 is emitted as reference light, and is diffracted in the hologram region 14 of the volume hologram element 10, so that reproducing light that is emitted along a traveling direction opposite to the reference light L1 shown in FIG. 9 can be emitted from the volume hologram element.

### Usage of Volume Hologram Element

Examples of the usage of the volume hologram element according to the embodiment of the present invention include an image display apparatus and an illumination device.

### Image Display Apparatus

An example of an image display apparatus is an image display apparatus comprising the volume hologram element according to the embodiment of the present invention, and a display element that emits an image to the volume hologram element.

In the above-described image display apparatus, the volume hologram element according to the embodiment of the present invention is disposed, for example, between the display element and a user. With this, the image (light corresponding to the image) that is emitted from the display element to the volume hologram element is diffracted in passing through the volume hologram element to be condensed and is imaged in the air. Light imaged in the air is observed as an aerial image by the user.

In such an image display apparatus, it is preferable that the volume hologram element is disposed such that the hologram region having a size in the in-plane direction greater than the display element covers the entire display element as observed from the user from a viewpoint of an observation image. The hologram region of the volume hologram element may be disposed to cover only a part of the display element.

The display element is a device that emits an image (static image or video) to be projected in the air.

The display element of the image display apparatus is not particularly limited, and a known display element that is used for various image display apparatuses can be used. An example of the display element is a display element having a display and a projection lens.

Examples of the display include a liquid crystal display (including liquid crystal on silicon (LCOS) and the like), an organic electroluminescence display, and a scanning type display using a digital light processing (DLP) mirror or a micro electro mechanical systems (MEMS) mirror.

An example of the display is a display that displays a multi-color image using light having wavelengths to be diffracted by the respective interference fringes formed in the hologram region of the volume hologram element.

As the projection lens of the display element, a known projection lens (collimating lens) that is used for various image display apparatuses is used.

### Head Mounted Display

An example of a preferred aspect of the image display apparatus is a head mounted display.

With the use of the volume hologram element according to the embodiment of the present invention, it is possible to configure a head mounted display that is capable of achieving both a wide field of view (FOV) and visually sufficient resolution while configuring a compact display apparatus.

In the head mounted display, to achieve both a wide FOV and a load of image rendering, a technique called foveated rendering is proposed. This is a technique in which the resolution of the peripheral visual field is suppressed to reduce a calculation load and the number of pixels of the display element using the fact that the human's visual sense can recognize only a blurred image in the peripheral visual field while being sensitive to resolution near the center of the visual line. As an example of such a technique, a technique described in JP2022-187199A has been suggested. As described in US11493772B, a technique in which a central portion where the center of the visual line primarily moves is made to be a high resolution display and the peripheral visual field is made to be a low resolution display has also been suggested.

A preferred embodiment of a head mounted display including the volume hologram element according to the embodiment of the present invention will be described with reference to FIG. 10A. A head mounted display 110 conceptually shown in FIG. 10A includes the volume hologram element 10 according to the embodiment of the present invention, and a display element 80 that emits an image to the volume hologram element according to the embodiment of the present invention, and as observed from the user side, a region 81 on a display surface of the display element 80 to be observed through the non-hologram region 13 of the volume hologram element 10 is a high resolution region.

The distribution of the human's visual line is primarily distributed in the eyeball front direction, and the angle distribution of the human's visual line is drawn as a cone of an apex angle of about 20° to 50° in a case where the front surface is 0°. The display of the range does not require large lens power in a head mounted display optical system, and in a case where the display element has sufficient resolution, satisfactory display for the user can be obtained. Accordingly, the non-hologram region of the volume hologram element 10 according to the embodiment of the present invention and a high resolution region (region 81) of the display element 80 may be provided in the cone.

In contrast, in the peripheral visual field, to realize a compact display apparatus and a wide FOV, it is necessary to bend light emitted from the display element with large lens power and make light incident on the pupils while suppressing the size of the display element. Note that, because the peripheral visual field is recognized to be blurred for the user as described above, resolution is not required. Accordingly, the hologram region of the volume hologram element 10 according to the embodiment of the present invention is provided in the region, so that it is possible to realize a wide FOV while configuring a compact display apparatus.

In the volume hologram element according to the embodiment of the present invention that is used for such a display apparatus, for example, in a case where the hologram element having a concentric circular shape shown in FIG. 1 is employed, a diameter of the non-hologram region 13 can be set to 0.3 to 1 cm and is preferably in a range of 0.5 to 0.8 cm. An outer diameter of the hologram region 14 is not particularly limited, but can be set to 1.5 to 8 cm and is preferably 2 to 5 cm. In a case where the outer peripheral end 14p of the hologram region 14 has an elliptical shape, a polygonal shape, and a shape different from such shapes, not a circumferential shape, a minimum diameter of a circle including the hologram region 14 may be in the above-described range.

An example of a further preferred aspect of a head mounted display is conceptually shown in FIG. 10B. A head mounted display 111 shown in FIG. 10B further includes an optical element 82 in addition to the configuration of the head mounted display 110 shown in FIG. 10A. The optical element 82 may be a single lens or may be a folded optical system, such as a so-called pancake lens (a folded optical system using a reflective polarizer, a half mirror, and a λ/4 plate; for example, described in WO2021/145446A), or a variable focus element (for example, described in JP2022-548455A or the like). Although the optical element 82 is provided between the volume hologram element 10 and the display element 80 in FIG. 10B, a form may be made in which the optical element 82 is provided on a pupil side (a side opposite to the display element 80) of the volume hologram element 10.

As the display element that is used for the head mounted display, a known display element, such as an LCD, an OLED, a micro LED array, and a light field display, can be used. The display element may have a planar shape or may have a curved shape for correction of optical aberration. The display element may be configured with a single display element or the high resolution region 81 and other regions may be configured as a combination of separate display elements. For example, a configuration is made in which the high resolution region 81 may be configured with an LCD or a micro LED array, and the other regions are configured with an OLED or a light field display.

### Illumination Device

An example of an illumination device is an illumination device comprising the volume hologram element according to the embodiment of the present invention and a light source.

An example of the light source is a light source, such as an LED, which emits light at a given radiation angle.

Such a light source is disposed at a position separated from the volume hologram element, and preferably, at the convergent point of the interference fringe formed in the hologram region, so that light (diverging light) emitted from the light source can be diffracted and condensed in the hologram region of the volume hologram element, and can be radiated as more converged light, such as parallel light, outside the illumination device. With this, an illumination device that has high utilization efficiency of light emitted from the light source and emits brighter light is obtained.

### Explanation of References

10: volume hologram element

11: first main surface

12: second main surface

13: non-hologram region

14: hologram region

14p: outer peripheral end

20: first interference fringe

21: fringe

22: second interference fringe

30: exposure device

31: prism

32: objective lens

33: concave lens region

34: convex lens region

40: hologram recording member

41: region

60: exposure device

62: laser

64: light source

68: polarization beam splitter

70A, 70B: mirror

72: substrate

74: hologram recording layer

80: display element

81: region (high resolution region)

82: optical element

100: volume hologram element

101, 102: exposure region

103: overlapping region

104: blank region

110, 111: head mounted display

F: convergent point

L1: reference light

L2: reproducing light

M: laser light

MA, MB: luminous flux

What is claimed is:

1. A method of manufacturing a volume hologram element that has a first main surface and a second main surface opposite to the first main surface, wherein a thickness of the volume hologram element is equal to or greater than 10 μm, the method comprising:
performing an interference exposure on a hologram recording member including a photosensitive hologram material by emitting reference light and object light, where the reference light and the object light have an optical axis in common,
disposing the hologram recording member such that a main surface of the hologram recording member is perpendicular to the optical axis,
in a single performance of the interference exposure, emitting the reference light and the object light to the hologram recording member such that only the reference light passes and the object light does not pass in a central portion of the hologram recording member intersecting the optical axis and such that both the reference light and the object light pass in a region surrounding the central portion in an in-plane direction of the hologram recording member, to thereby form a non-hologram region and a hologram region inside the hologram recording member, the non-hologram region corresponding to a region where only the reference light passed and not having an interference fringe that diffracts light, the hologram region corresponding to a region where both the reference light and the object light passed and having an interference fringe that selectively diffracts light having a specific wavelength, where the interference fringe formed by the single performance of the interference exposure is formed over the entire hologram region, has no discontinuous portion, and is continuous inside the hologram region excluding an interface of different portions of the hologram region, and
performing the interference exposure plural times to form, over the entire hologram region, a plurality of interference fringes, wherein a number of the plurality of interference fringes is identical to a number of the plural times of performance of the interference exposure and each of the plurality of interference fringes selectively diffracts light having a different wavelength.

2. The method according to claim 1,
wherein wavelengths of the reference light and the object light emitted in, of the plural times of the interference exposure, a second or later interference exposure are same as wavelengths of the reference light and the object light emitted in a first interference exposure, and incidence angles of the reference light and the object light emitted in the second or later interference exposure with respect to the hologram recording member are different from incidence angles of the reference light and the object light emitted in the first interference exposure with respect to the hologram recording member.

3. The method according to claim 1,
wherein the thickness is 50 to 800 μm.

4. The method according to claim 1,
wherein, in the hologram region, a slant angle of at least one interference fringe among the plurality of interference fringes monotonously increases from the non-hologram region toward an outer peripheral end of the hologram region and a period of at least one interference fringe among the plurality of interference fringes is monotonously narrowed from the non-hologram region toward the outer peripheral end of the hologram region.

5. The method according to claim 3,
wherein, in the hologram region, a slant angle of at least one interference fringe among the plurality of interference fringes monotonously increases from the non-hologram region toward an outer peripheral end of the hologram region and/or a period of at least one interference fringe among the plurality of interference fringes is monotonously narrowed from the non-hologram region toward the outer peripheral end of the hologram region.

6. The method according to claim 1,
wherein, in the hologram region, a slant angle of at least one interference fringe among the plurality of interference fringes monotonously increases from the non-hologram region toward an outer peripheral end of the hologram region or a period of at least one interference fringe among the plurality of interference fringes is monotonously narrowed from the non-hologram region toward the outer peripheral end of the hologram region.

7. The method according to claim 1,
wherein, in a case where light having a wavelength to be diffracted by at least one interference fringe among the plurality of interference fringes is incident on the first main surface in the hologram region, an angle between a vertical line drawn from a convergent point where diffracted light diffracted by the at least one interference fringe and emitted from the second main surface converges, to the second main surface and a line segment that connects the convergent point and an outer peripheral end of the hologram region is equal to or greater than 50°.

8. The method according to claim 3,
wherein, in a case where light having a wavelength to be diffracted by at least one interference fringe among the plurality of interference fringes is incident on the first main surface in the hologram region, an angle between a vertical line drawn from a convergent point where diffracted light diffracted by the at least one interference fringe and emitted from the second main surface converges, to the second main surface and a line segment that connects the convergent point and an outer peripheral end of the hologram region is equal to or greater than 50°.

9. The method according to claim 4,
wherein, in a case where light having a wavelength to be diffracted by at least one interference fringe among the plurality of interference fringes is incident on the first main surface in the hologram region, an angle between a vertical line drawn from a convergent point where diffracted light diffracted by the at least one interference fringe and emitted from the second main surface converges, to the second main surface and a line segment that connects the convergent point and an outer peripheral end of the hologram region is equal to or greater than 50°.

10. The method according to claim 1,
wherein three or more interference fringes are formed as the plurality of interference fringes over the entire hologram region by performing the interference exposure three or more times, and
in a case where three or more kinds of light having wavelengths to be selectively diffracted by the respective three or more interference fringes are incident on the first main surface, the three or more kinds of light diffracted by the three or more interference fringes in the hologram region, respectively, and emitted from the second main surface converge at the same convergent point.

11. The method according to claim 3,
wherein three or more interference fringes are formed as the plurality of interference fringes over the entire hologram region by performing the interference exposure three or more times, and
in a case where three or more kinds of light having wavelengths to be selectively diffracted by the respective three or more interference fringes are incident on the first main surface, the three or more kinds of light diffracted by the three or more interference fringes in the hologram region, respectively, and emitted from the second main surface converge at the same convergent point.

12. The method according to claim 4,
wherein three or more interference fringes are formed as the plurality of interference fringes over the entire hologram region by performing the interference exposure three or more times, and
in a case where three or more kinds of light having wavelengths to be selectively diffracted by the respective three or more interference fringes are incident on the first main surface, the three or more kinds of light diffracted by the three or more interference fringes in the hologram region, respectively, and emitted from the second main surface converge at the same convergent point.

13. The method according to claim 7,
wherein three or more interference fringes are formed as the plurality of interference fringes over the entire hologram region by performing the interference exposure three or more times, and
in a case where three or more kinds of light having wavelengths to be selectively diffracted by the respective three or more interference fringes are incident on the first main surface, the three or more kinds of light diffracted by the three or more interference fringes in the hologram region, respectively, and emitted from the second main surface converge at the same convergent point.

14. 14. A method of manufacturing an image display apparatus comprising a volume hologram element and a display element that emits an image to the volume hologram element,
wherein the volume hologram element is manufactured by the method according to claim claim 1
